(19) United States
(12) Patent Application Publication
(10) Pub. No.: US 2024/0153715 A1
(43) Pub. Date: May 9, 2024

(54) METHOD OF MAKING HIGH VOLUMETRIC ENERGY DENSITY CAPACITOR

(71) Applicant: THE PENN STATE RESEARCH FOUNDATION, University Park, PA (US)

(72) Inventors: Ramakrishnan Rajagopalan, DuBois, PA (US); Hossein Hamedi, University Park, PA (US); Clive A. Randall, University Park, PA (US)

(21) Appl. No.: 18/264,145

(22) PCT Filed: Feb. 9, 2022
(86) PCT No.: PCT/US2022/015732

§ 371 Date: Aug. 3, 2023

Related U.S. Application Data
(60) Provisional application No. 63/147,965, filed on Feb. 10, 2021.

(51) Int. Cl. H01G 11/06; H01G 11/34; H01G 11/50; H01G 11/86

(52) U.S. Cl. CPC H01G 11/06; H01G 11/34; H01G 11/50; H01G 11/86

(57) ABSTRACT

A method of fabricating a capacitor can include prelithiating a carbon material to form a first layer for the capacitor. The first layer including an anode or being an anode layer. A second layer can be positioned between the first layer and a third layer. The second layer can be or include a membrane and the third layer can be or include a cathode. The third layer can include activated carbon or utilize activated carbon as a cathode. Capacitors can be formed by use of this method and devices can utilize such capacitors. Instead of relying on lithium in metallic form, a carbon material can be prelithiated to include lithium ions therein to form an anode for the LIC that avoids use of lithium foil or lithium powder in the LIC and also avoid use of lithium in a metallic form in the LIC.

### CROSS-REFERENCE TO RELATED APPLICATIONS

The present application claims priority to U.S. Provisional Patent Application No. 63/147,965, which was filed on Feb. 10, 2021. The entirety of this provisional patent application is incorporated by reference herein.

### STATEMENT REGARDING FEDERALLY SPONSORED RESEARCH

This invention was made with government support under Grant No. EEC1160483 awarded by the National Science Foundation. The Government has certain rights in the invention.

### FIELD

This innovation relates to capacitors, the fabrication of capacitors, and devices that can include capacitors. In some embodiments, the capacitor can be a coin cell type capacitor or a pouch cell type capacitor. In some embodiments, the capacitor can be a lithium ion capacitor that is configured as a coin cell. Other embodiments can utilize a pouch cell configuration. Embodiments can utilize different types of cells and have different volumetric energy density values.

### BACKGROUND

A lithium-ion capacitor (LIC) can store more energy compared to electric double-layer capacitors (EDLC) due to the Faradaic lithium intercalation at the anode and higher voltage window (˜4V) of Li-ion electrolytes. Due to the hybrid design, LIC has the advantage of higher capacity, high-rate capability and longer cycle life making them attractive as a potential standalone energy storage device or in parallel with batteries offering system solution. Most commercially available lithium-ion capacitors are based on either prismatic form factor or wrapped cylindrical cells that can provide large capacitance in the order of 100-2000 Farad (F).

### SUMMARY

One of the major limitations to the fabrication of lithium ion capacitors is the need for using lithium foil as a sacrificial electrode in the cells. This is needed in order to lithiate the graphite anode which is a prerequisite for the lithium-ion capacitor to be functional. Other researchers have shown that the use of lithium powder mixed with graphite could be directly used as anode. However, in both cases, lithium in metallic form remains in the packaged lithium ion capacitors. We have developed methods of lithium ion capacitor (LIC) fabrication, LIC designs, and devices that can use one or more such LICs that can avoid use of lithium in metal form within the LIC(s). Instead of relying on lithium in metallic form, a carbon material (e.g. graphite) can be prelithiated to include lithium ions therein to form an anode for the LIC that avoids use of lithium foil, lithium powder and also avoid use of lithium in a metallic form. Instead of use of lithium in metallic form (e.g. lithium foil or lithium powder), lithium ions embedded in the prelithiated carbon material provides a source of lithium ions. This anode layer of material can be utilized in conjunction with an activated carbon cathode layer for the LIC in some embodiments to help provide a further improved performance for the LIC.

In some embodiments of our LIC, we determined that the energy stored in the cell can depend on the relative mass loading of carbon cathode to graphite anode. In order to achieve packaged energy densities >10 Wh/L, a mass loading close to 4 can often be utilized. Such a mass loading can mean that the capacitor can have an ultrathick high surface area carbon cathode. In order to avoid severe mass transfer limitations in thick electrodes, a balance of high surface area ultramicropores in the range of 0.8 nm-2 nm along with interconnected mesopores that can act as local reservoirs of electrolyte ions while promoting efficient ion transport through the electrode can be utilized. The creation of micropores and mesoporosity can be based on a process that involves synthesis of polyfurfuryl alcohol blends. For example, furfuryl alcohol can be acid polymerized in the presence of other polymers such as polyethylene glycol or polyethylene glycol diacids. Alternately, furfuryl alcohol can be simultaneously polymerized using a co-monomer such as phloroglucinol to yield a resultant polymer during pyrolysis undergo phase separation to create micropores and mesopores whose dimensions can be changed through controlled activation. Prelithiating graphite anodes can also be utilized to help facilitate the assembly and fabrication of an LIC in a coin cell or other type of cell arrangement. As may be appreciated from the above, it should be understood that prelithiation of other carbon material can be utilized for the anode as a substitute for graphite in some embodiments.

The prelithiation of the carbon material can refer to lithium atoms being included within the carbon material. The lithium atoms can be included prior to the incorporation of a layer of carbon material having the lithium atoms added therein into a LIC to provide a prelithiated carbon material, for example.

Pore size distribution of the cathode can help ensure that all the surface area is accessible to the electrolyte. We determined that utilization of a bimodal pore size design can allow embodiments of the LIC to provide a capacitance that can be almost doubled relative to a carbon which is purely microporous.

We determined that embodiments of the LIC can provide adequate energy (e.g. ˜5 times more than EDLC) while handling load currents 2-5 times that of rechargeable battery of similar form factor and good cyclability (e.g. 3 times that of a conventional battery) while being assembled in a smaller form factor such as coin cell type configuration. This can create new application spaces in microelectronics, internet of things (IOT), and health sensor applications, among other applications.

In addition to the capacitance, equivalent series resistance can be designed to determine the overall performance of the capacitor. Efforts to reduce equivalent series resistance while maintaining high specific capacity and good rate capability in the energy storage device can conventionally utilize ultrathick porous current collectors which often suffer from oxidation or self-passivation along with severe mass transfer limitations when filled with electrode materials. In the case of prismatic or cylindrical cell designs, for example, the use of current collectors often limits the electrode thicknesses to 0.1 to 0.2 mm in conventional capacitors.

We determined that the ability to form freestanding carbon film electrodes without the need for a current collector when assembled in a coin cell or pouch cell can allow the possibility to make ultrathick carbon cathodes for LIC fabrication for embodiments of our LIC. Such design criteria for some embodiments of the capacitor can provide significant improvements over conventional designs. For example, current coin cell electrochemical capacitors in the market are based on symmetric EDLCs. Conventional, commercial coin cell capacitors have specifications ranging from 0.1 F to 1.5 F and a cell voltage of 2.7 or 5.5V. The packaged volumetric energy density of these conventional devices is about 1 to 2.5 Wh/L as shown in Table 1 (below). We determined that a significantly higher voltage can be achieved by use of a modular design that involves connecting capacitor cells in series. This results in increasing the equivalent series resistance of the device and most devices with small form factor that can have an Equivalent Series Resistance (ESR) at 1 kHz ranging from 20 to 30Ω, for example.

TABLE 1
Comparison of available commercial electrochemical
coin cell capacitors

| | | | | | ESR | |
|---|---|---|---|---|---|---|
| | | | | | @ 1 | Energy |
| | Volume | Mass | Capacitance | Voltage | kHz | density |
| Manufacturer | cc | g | F | V | Ω | Wh/L |
| Lelon | 2.47 | — | 1.5 | 5.5 | 30 | 2.55 |
| Elna Dynacap | 5.81 | — | 1 | 5.5 | 30 | 0.72 |
| Kemet FC | 3.63 | 6.7 | 1 | 5.5 | 7 | 1.16 |
| series | | | | | | |
| Cooper KW | 3.21 | 9.1 | 1 | 5.5 | 30 | 1.31 |
| series | | | | | | |
| Eaton KR | 2.58 | 10.4 | 1 | 5.5 | 30 | 1.63 |
| series | | | | | | |
| Cap-xx | 2.11 | 2.11 | 1.2 | 5 | 0.03 | 0.29 |
| Prismatic | | | | | | |
| AVX | 2.67 | — | 1 | 2.1 | 0.49 | 1.56 |
| Prismatic | | | | | | |
| An LIC | 0.5 | 1.8 | 4.7 | 3.8 | 6 | 13 |
| embodiment of | | | | | | |
| this work | | | | | | |

Embodiments of the capacitor for coin cell and pouch cell configurations can be stable at various temperature ranges. For example, the capacitor can be stable in a temperature range of −40° C. to 85° C., −40° C. to 70° C., or a temperature range that ranges from room temperature to 70° C.-85° C. It should be appreciated that the design of an embodiment of the capacitor for a particular embodiment can be optimized for a desired optimum temperature range as well.

In some embodiments, a high energy density can be achieved due to the assembly of ultrathick high surface area carbon cathodes and prelithiated graphite anodes in a stainless steel coin cell prototype or pouch cell prototype. Example thicknesses for the carbon cathodes can be, for example, 0.5 mm, 0.6 mm, 0.7 mm, greater than 0.2 mm and less than 1 mm, as well as other thicknesses. Example thicknesses for the prelithiated graphite anodes can include 0.05 mm, 0.1 mm, 0.15 mm, and 0.2 mm. The fabricated coin cell capacitor can meet energy storage requirements of wearable health sensor and IOT sensor platforms with high volumetric energy efficiency when used in conjunction with energy harvesters. The fabricated pouch cell capacitor embodiments can be configured to meet energy storage requirements for a number of other applications (e.g. car batteries, laptop computer batteries, smart phone batteries, etc.).

In some embodiments, prelithiation of a graphite anode using a short-circuiting approach was successfully utilized to provide significant improved performance without having to utilize a sacrificial lithium foil layer or use of lithium in metal form. Prelithiation can result in the graphite being in a fully lithiated state. In some embodiments, the prelithiated graphite can provide an electrode potential below 0.1 V vs Li⁺/Li, for example. Prelithiation of a carbon material can also help permit the LIC to be designed and fabricated so the formed LIC does not contain lithium in metal form (e.g. there is no lithium foil or lithium powder in the LIC). Instead, lithium ions embedded within the carbon material via the prelithiation process can provide a source of lithium ions for the anode.

Additionally, a stable ultrathin solid electrolyte interphase on the anode that can help provide good cycling stability for the device can also be formed. High capacity carbon cathode based on furfuryl alcohol precursor with specific capacitance as high as 60 F/g (based on total mass of the cathode and anode) and limited mass transfer effects was fabricated and electrode loading was achieved in such an embodiment that was three times greater than conventional EDLC commercial electrodes. We determined that the interconnected micro-and mesoporous network in the synthesized carbons in this embodiment allowed for the fabrication of ultrathick carbon cathode (e.g. at least 0.6 mm thick) with mass loading as high as 30 mg/cm², which is three times greater than state-of-the-art EDLC carbon electrodes. This mass loading of 30 mg/cm² can be based on a freestanding carbon film type design. To further increase the loading, a porous aluminum current collector can be utilized, which may be able to extend the thickness beyond 0.6 mm to a thickness of up to 1 mm in some embodiments. Other current collectors can alternatively be utilized to provide other embodiments of the LIC having other thickness ranges as well. Other embodiments can also utilize other types of activated carbon instead of the furfuryl alcohol precursor based activated carbon noted above.

In one embodiment, the ultrathick carbon cathode was 0.6 mm in thickness and a prelithiated graphite anode was assembled together with the carbon cathode using a polyvinylidene fluoride (PVDF) gel electrolyte membrane that was 0.1 mm thick soaked in lithium electrolyte in an inert glovebox or dry room facility to form a packaged coin cell capacitor. This was able to form a particular single coin cell embodiment (20 mm diameter×1.6 mm thick) that had a maximum voltage of 3.8V with ESR <10Ω and high volumetric energy density of 13 Wh/L. The low ESR and ultralow leakage current (˜1 μA) for this particular embodiment made it a unique device capable of handling a wide range of charging or load currents (10 μA-50 mA) for such a small form factor. This embodiment of our LIC worked well and avoided use of lithium in metal form (e.g. lithium foil or lithium powder). Other embodiments can have different form factors and also have similar improved functionality and features as compared to conventional LICs. Other embodiments can utilize polypropylene based gel electrolyte or polyacrylonitrile based gel electrolyte instead of PVDF. It is also contemplated that another type of prelithiated carbon material can be utilized instead of prelithiated graphite for the cathode.

A capacitor is provided. For example, some embodiments of the capacitor can be configured and structured as a lithium-ion capacitor. In some embodiments, the capacitor can be included in different types of devices (e.g. rechargeable battery configurations, vehicle hybrid battery systems, etc.). Embodiments of the capacitor can include a cathode layer, an anode layer, and a membrane between the cathode layer and the anode layer.

Some embodiments of the capacitor can also include a spacer layer attached to the cathode layer. The spacer layer can be a layer of metal (e.g. stainless steel, other metal) or can include a layer of metal, for example.

The anode layer can be comprised of a prelithiated carbon material coated on a metal or a prelithiated graphite coated on a metal in some embodiments. The prelithiation of the carbon material can be provided via a chemical approach or via a short circuit approach. For example, prelithiated graphite can be prelithiated via a chemical approach or via a short circuit approach.

The cathode layer can include activated carbon. The activated carbon can be activated carbon synthesized based on polymerization and pyrolysis of furfuryl alcohol or can be another type of activated carbon.

The membrane can be prelithiated as well in some embodiments. The membrane can be prelithiated via a chemical approach or via a short circuit approach, for example.

A method of fabricating a capacitor is also provide. The method can include forming a cathode layer, an anode layer and a membrane between the cathode layer and the anode layer to form a capacitor. The formed capacitor can be an embodiment of an above discussed capacitor for example.

For instance, the formed capacitor can include a cathode layer, an anode layer, and a membrane between the cathode layer and the anode layer. Some embodiments of the capacitor can also include a spacer layer attached to the cathode layer. The spacer layer can be a layer of metal (e.g. stainless steel, other metal) or can include a layer of metal, for example. The anode layer can be comprised of a prelithiated carbon material coated on a metal or a prelithiated graphite coated on a metal in some embodiments. The cathode layer can include activated carbon. The membrane can be prelithiated as well in some embodiments.

Some embodiments of the method of fabricating a capacitor can include prelithiating a carbon material to form a first layer for the capacitor, the first layer including an anode; positioning a second layer between the first layer and a third layer, the second layer including a membrane and the third layer including a cathode. The cathode can include activated carbon.

Embodiments of the method can also include other steps. For instance, the method can include connecting a fourth layer to the third layer, the fourth layer comprised of a metal. In some embodiments, the fourth layer can be a spacer layer that is comprised of metal.

Embodiments of the method can be configured so that the capacitor can be formed so that the capacitor does not include lithium in metal form. For instance, the capacitor can be formed so that the capacitor does not include a layer of lithium foil or lithium powder.

In some embodiments, the capacitor that is formed can be a lithium ion capacitor (LIC). In some embodiments, the capacitor that is formed can consist of the first layer, the second layer, and the third layer (e.g. the LIC only has the first, second, and third layers). In other embodiments, the capacitor can include other layers. In some embodiments, the capacitor is a lithium ion capacitor (LIC) and consists of the first layer, the second layer, the third layer and a fourth layer connected to the third layer where the fourth layer is comprised of metal, for example. As another example, other embodiments of the capacitor can include additional layers or other materials.

In some embodiments, the third layer of the formed capacitor can include activated carbon. The activated carbon can be synthesized based on polymerization and pyrolysis of furfuryl alcohol.

The carbon material of the first layer can be graphite or can be another type of carbon material. For example, the carbon material can be a carbon anode, a graphene-based anode, a carbon onion anode, or a silicon carbon composite anode.

A device is also provided. Embodiments of the device can include at least one capacitor. The at least one capacitor can include a first layer, a second layer, and a third layer. The second layer can be positioned between the first layer and the third layer. The second layer can be a membrane, the first layer can include a prelithiated carbon material, and the third layer can include activated carbon.

In some embodiments, the device can be included in a rechargeable battery, an on-board computer memory backup circuit; a real time clock—battery backup; a utility meter; a solar battery backup and energy storage device; a hybrid car battery, an electric vehicle battery, a hybrid vehicle battery, a laptop computer battery, a smart phone battery, a tablet battery, and an industrial control device. In other embodiments, the device can be included in other devices or systems.

The first layer, second layer, and third layer for each of the at least one capacitor of the device can be arranged without a layer of lithium in metal form positioned between the layers or adjacent the layers and without the layers having lithium in metal form. For example, there may not be any lithium foil or lithium powder included in the layers or adjacent the layers.

Embodiments of device that include at least one capacitor can include only a single capacitor or can include at least two capacitors. Each of the capacitors can have the first layer, the second layer, and the third layer. For multiple capacitor devices, the capacitors can be connected to each other. In some configurations, the multiple capacitors can be within a single pouch cell, for example.

Other details, objects, and advantages of the invention will become apparent as the following description of certain exemplary embodiments thereof and certain exemplary methods of practicing the same proceeds.

### BRIEF DESCRIPTION OF THE DRAWINGS

Exemplary embodiments of a capacitor, a device including at least one capacitor, and a method of making and using a capacitor are shown in the accompanying drawings and certain exemplary methods of making and practicing the same are also illustrated therein. It should be appreciated that like reference numbers used in the drawings may identify like components.

FIG. 1 is a schematic diagram of a first exemplary embodiment of an LIC.

FIG. 2 is a Ragone plot for an embodiment of the LIC and a conventional lithium ion rechargeable battery (LIR) battery. Energy and power density were computed based on constant current experiments in which the conventional LIR battery was charged and discharged between 3V and 4.2V while the embodiment of our LIC was charged and discharged between 2.2V and 3.8V, respectively.

FIG. 3 is a graph illustrating the relative capacity of the LIC and conventional LIR battery vs C-rate. The conventional LIR battery is labeled as “Li-on Commercial Battery” and the embodiment of our LIC is labeled as the “Li-ion Capacitor.”

FIG. 4 is a graph illustrating the energy efficiency vs. C-rate for the LIC and conventional LIR battery. The LIR battery is labeled as “Li-on Commercial Battery” and the embodiment of our LIC is labeled as the “Li-ion Capacitor.”

FIG. 5 is a graph illustrating capacity vs runtime for constant power discharge of a conventional LIR battery and the LIC. Both of the devices were charged at constant current of 8 mA and the device were run between 3V and 3.8V. For each constant power cycle, the devices were cycled 100 times. The conventional LIR battery is labeled as “Li-on Commercial Battery” and the embodiment of our LIC is labeled as the “Li-ion Capacitor.”

FIG. 6 is a graph illustrating capacity retention vs. run time for the conventional LIR battery and LIC capacitor charged and discharged continuously at constant current of 8 mA. The LIR battery was charged between 3V to 4.2V while the LIC was charged between 2.5V to 3.8V respectively. The conventional LIR battery is labeled as “Li-on Commercial Battery” and the embodiment of our LIC is labeled as the “Li-ion Capacitor.”

FIG. 7 is a graph illustrating long term cycling results. Long term cycling study under constant current constant voltage charging conditions. The LIC was charged to 3.8V at 2.5 mA, held at 3.8V for 1 hour before being discharged to 2.5V at 2.5 mA.

FIG. 8 is a flow chart illustrating an exemplary process by which the LIC can be charged using a constant current source or flexible solar cell. For an exemplary process, the maximum charging voltage can be set to a pre-selected limit value (e.g. 3.8V). A buck converter can be used to provide a steady voltage output for a pre-selected voltage output (e.g. 3V) to a sensor platform (e.g. the Health sensor platform). For some experiments of a prototype discussed herein, when the voltage reached 3.8V, the current charging source was disconnected and the health sensor was run directly by the capacitor until the voltage reaches a minimum voltage (Vmin), which was set to 3.4V for demonstration. Other embodiments can utilize other types of charging methodologies.

FIG. 9 is a photograph of an exemplary health sensor system.

FIG. 10 is a block diagram of an exemplary health sensor system.

FIG. 11 is a graph illustrating results of demonstration of an exemplary embodiment of a health sensor platform using 4 7 F LIC packaged in a 2016 stainless coin cell.

FIG. 12 is a graph illustrating results of demonstration of the exemplary embodiment of a health sensor platform using 4 7 F LIC packaged in a 2016 stainless coin cell.

FIG. 13 is a photograph of a screen displaying sensor activity results from a demonstration of the exemplary embodiment of a health sensor platform using 4 7 F LIC packaged in a 2016 stainless coin cell.

FIG. 14 is a graph illustrating results of demonstration of an exemplary embodiment of a health sensor platform using 4 7 F LIC packaged in a 2016 stainless coin cell.

FIG. 15 is a graph illustrating the pulsed load current profile of an exemplary embodiment of a health sensor platform under operation,

FIG. 16 is a graph illustrating the voltage profile of a conventional CR2032 primary lithium-ion battery while running the health sensor platform.

FIG. 17 is a graph illustrating a voltage profile of an embodiment of our LIC continuously running the health sensor platform while being charged by solar cell or constant current source.

FIG. 18 is a photograph of the exemplary embodiment of a sensor module.

FIG. 19 is a graph illustrating a pulsed load current profile of an internet of things (IOT) sensor system on module during operation.

FIG. 20 is a graph illustrating a voltage profile of an embodiment of our LIC continuously running the IOT sensor system for more than 80 Cycles (24 hour run time) charged using a constant current source.

FIG. 21 is a flow chart illustrating an exemplary process for fabrication of an embodiment of our LIC.

FIG. 22 is a schematic drawing illustrating an exemplary prelithiation process for fabrication of lithiated graphite to be used as an anode in lithium-ion pouch cell capacitors.

FIG. 23 is a series of photographs illustrating an exemplary embodiment of our LIC capacitor and an exemplary embodiment of lithiated graphite (which can be golden yellow in color) prepared using an embodiment of our LIC fabrication process, which utilized an embodiment of our anode prelithiation process.

FIG. 24 is a photograph of a demonstration for fabrication on a single cell pouch LIC using a high surface area carbon cathode and a prelithiated graphite anode in accordance with an exemplary embodiment of our LIC fabrication process.

FIG. 25 shows the galvanostatic constant current charge/discharge performance of the fabricated pouch cell embodiment shown in FIG. 24 cycled between 2.5V and 3.8V at a constant current of 10 mA.

FIG. 26 shows the capacitance cycling performance of fabricated pouch cell embodiment shown in FIG. 24 for the first 50 cycles.

FIG. 27 shows the coulombic efficiency of fabricated pouch cell embodiment shown in FIG. 24 for the first 50 cycles.

FIG. 28 shows the energy efficiency of fabricated pouch cell embodiment shown in FIG. 24 for the first 50 cycles.

FIG. 29 is a schematic view of a hybrid module assembly 31 of a lithium-ion rechargeable battery 31B with multiple LIC cells 31C in parallel within the same pouch cell assembly in accordance with an embodiment of our invention.

FIG. 30 is a perspective view of the exemplary embodiment of the hybrid module assembly 31 of a lithium-ion rechargeable battery 31B with multiple LIC cells 31C in parallel within the same pouch cell assembly shown in FIG. 29.

### DETAILED DESCRIPTION

### Exemplary Capacitor Structure

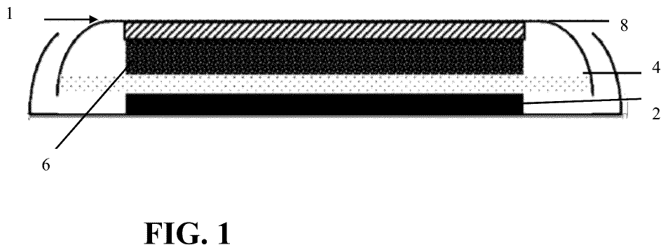

Referring to FIG. 1, a lithium ion capacitor (LIC) 1 can include multiple layers. These layers can include a first layer 2, a second layer 4, a third layer 6, and a fourth layer 8.

The first layer 2 can be structured as an anode. The first layer 2 can be a layer of carbon material that is prelithiated. The prelithiated carbon material can be, for example, prelithiated graphite, prelithiated graphene, a prelithiated hard carbon anode, a prelithiated graphene-based anode, a prelithiated nanostructured carbon material such as carbon onions and silicon carbon composite anodes. For example, the first layer 2 can be a layer of material that includes graphite coated on copper. In some embodiments, the first layer 2 can be structured as a sheet of material (e.g. a sheet of copper that has its exterior surface entirely coated with graphite, substantially coated with graphite, entirely covered with a prelithiated carbon material, or substantially covered with a prelithiated carbon material). For instance, the first layer 2 can be a sheet of material that consists essentially of graphite coated on copper or only include graphite coated on copper in some embodiments. This sheet of material can be prelithiated to prelithiate the graphite of the sheet of material.

The second layer 4 can be structured as a membrane. The membrane layer can include a layer of polymeric material. The second layer 4 can include, for example, polyvinylidene fluoride (PVDF) and/or its copolymers such as, for example, polypropylene, polyacrylamide, polyvinyl alcohol, cellulose acetate or nitrocellulose. In some embodiments, the second layer 4 can only include a polymeric material (e.g. be a sheet of PVDF, polypropylene, polyacrylamide, polyvinyl alcohol, cellulose acetate or nitrocellulose, etc.).

The third layer 6 can be structured as a cathode. The third layer 6 can include a sheet of activated carbon or otherwise include activated carbon. In some embodiments, the third layer 6 can only include a layer of activated carbon or a sheet of activated carbon (e.g. consist of activated carbon or consist essentially of activated carbon).

The fourth layer 8 can be a spacer layer that is composed of metal. For example, the fourth layer 8 can be a sheet of stainless steel or include stainless steel. In other embodiments, the spacer layer can be composed of another type of metal or include another type of metal. In some embodiments, the fourth layer 8 can consist essentially of metal or only include a metal.

The second layer 4 can be positioned so that the second layer 4 is between the first layer 2 and the third layer 6. The third layer 6 can be positioned so the third layer 6 is between the fourth layer 8 and the second layer 4. The first layer 2 can be spaced apart from the fourth layer 8 by the second layer 4 and the third layer 6.

In some embodiments, a second side of the first layer 2 can be opposite the first side of the first layer 2. The second side of the first layer 2 can contact a first side of the second layer 4. A second side of the second layer 4 can contact a first side of the third layer 6. The second side of the third layer 6 can contact a first side of the fourth layer 8.

It should be appreciated that the second side of the third layer 6 can be opposite the first side of the third layer 6. The second side of the second layer 4 can be opposite the first side of the second layer 4.

In some orientations, the first side of each layer can be its bottom side and the second side of each layer can be its top side. In other orientations, the first side of each layer can be a front, rear, or top side and the second side of each layer can be the opposite of that layer's first side (e.g. the second side can be the rear if the first side is the front, etc.). This same assembly can be utilized in a cylindrical assembly in which the layers are wrapped around to form a tubular type structure or cylindrical structure.

The LIC can be configured as a coin capacitor or a pouch capacitor in some embodiments. It is also contemplated that embodiments are not limited to coin capacitors and pouch capacitors. Other LIC configurations can utilize other types of shapes or assembly configurations to meet a particular set of design criteria. Embodiments of the LIC can be utilized in devices. One or more of the LICs can be arranged to meet a particular set of design objectives. In some designs, there can be an arrangement of LICs in series and/or in parallel. For example, a device can include a group of LICs in parallel and have multiple such groups of LICs arranged in parallel. As another example, a group of LICs can be arranged in parallel or in series.

### Exemplary Capacitor Fabrication

In some embodiments, the third layer 6 can be formed from activated carbon. The activated carbon can be synthesized based on polymerization and pyrolysis of furfuryl alcohol. For example, cathode material can be fabricated by combining 85 wt % of the activated carbon, 7.5 wt % acetylene black, and 7.5 wt % Teflon dispersion. The mixture can be blended and pressed using a mortar and pestle (or other type of blending and pressing device) to produce a homogeneous paste. Using a roller, the paste can be flattened into a film with a uniform thickness. A hollow punch or other type of film shaping device can be utilized to cut the film into a particular shape (e.g., 16 mm circular electrodes, polygonal shaped electrodes, circular shaped electrodes, etc.). In some embodiments, the thickness of the fabricated electrodes can be controlled between 0.2-1 mm or in a range that is greater than 0.2 mm to 1 mm. In other embodiments, other thickness control ranges can be utilized to meet a particular set of design criteria (e.g. a range of 0.5 mm to 1 mm, a range of 0.6 mm to 1 mm, a range of greater than 0.2 mm to about 1 mm, which can be 1 mm +/−0.1 mm for example, etc.).

In addition to or as an alternative to the carbon synthesized from furfuryl alcohol, carbon derived from biomass precursors such as coconut shell, olive shell, peanut shell, corn cob, other organic plant matter or animal matter etc. can be used as well as carbohydrate sources that include cellulose and sugar, crosslinking polymeric sources such as polyvinylidene chloride, phenolic resin and polyimides. The surface area of the carbonized precursors can be further activated using steam, CO₂ or a chemical activation method using potassium hydroxide, phosphoric acid or zinc chloride to form the activated carbon for the activated carbon of the third layer 6. The bimodal porosity can also be created in some embodiments by pyrolyzing the precursor using a sacrificial hard or soft template such as mesoporous silica, zeolite or triblock copolymers such Pluronic F127, for example.

In order to form an ultrathick carbon electrode (e.g. greater than 0.5 mm in thickness) for some embodiments, the carbon can be synthesized to possess a bimodal interconnected porosity that includes ultramicropores and mesopores. For some embodiments, the ultramicropores can be in the range of 0.8-2 nm and the mesopores can be in the range of 5-10 nm. The ultramicropores can be utilized to help provide a high surface area for the ions to form a double layer. The mesopore range for the carbon material can help in ease of accessibility of the smaller ultramicropores. The bimodal interconnected porosity feature can help provide larger capacitance relative to carbon material with only ultramicropores.

The bulk density of the activated carbon can also be >0.45 g/cc and can range as high as 0.7 g/cc in some embodiments. Bulk densities of the fabricated electrode for the third layer 6 can be in a range of ˜0.5-0.6 g/cc.

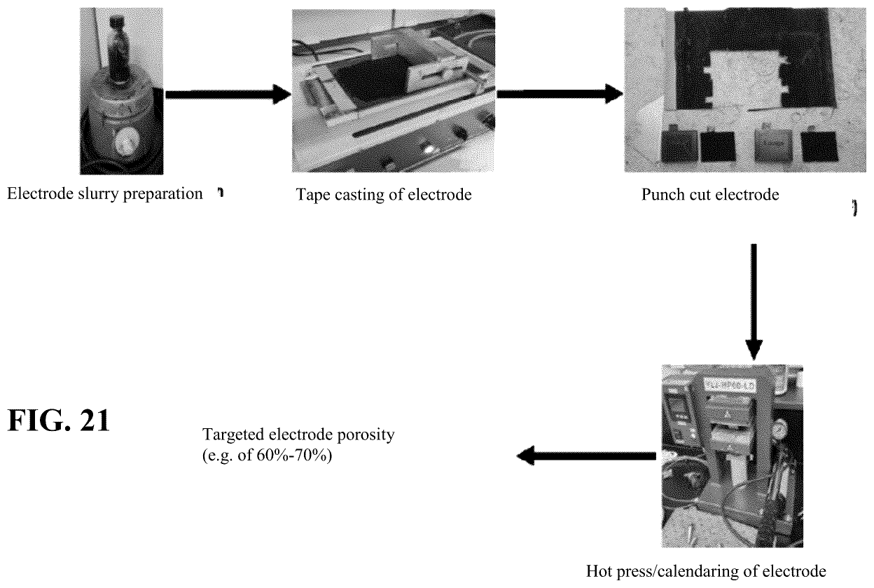

FIG. 21 illustrates an exemplary process for fabrication of the third layer 6, which can utilize a high surface area carbon cathode coating on a metal (e.g. high surface area carbon coating a sheet or strip of foil composed of aluminum or copper etc.). For example, adherent and thick high surface area carbon cathodes can be deposited onto a current collector for fabrication of lithium-ion capacitor pouch cells. The metal current collector can be a sheet or strip of metal (e.g. aluminum or copper, etc.). Electrode slurries can be prepared using a pre-selected concentration of a high surface area carbon mixed with other constituents. (e.g. 85 weight percent (wt %), 10 wt % PVDF, 5 wt % Acetylene black as conductive additive and N-methyl pyrrolidone as solvent). The electrode slurries can be tapecasted onto the current collector followed by vacuum drying at a pre-selected drying temperature (e.g. 120° C. or other suitable temperature). The dried electrodes can then be punched out with a pre-selected mass loading(e.g. a mass loading of 13-15 mg/cm²) and hot pressed or calendared using a rolling press to fabricate the cathode electrode of the LIC with a pre-selected porosity (e.g. a porosity of 60%-70%).

The second layer 4 can be formed as a membrane layer. In some embodiments, a PVDF membrane with 0.1 mm thickness can be sandwiched between the first layer 2, structured as a prelithiated graphite anode, and the third layer 6 fabricated from activated carbon to function as a cathode. The combination can be positioned in a cell with a pre-selected width or diameter (e.g. 20 mm diameter), a pre-selected thickness (e.g. 1.6 mm thickness). Depending on the shape, the cell can also have a pre-selected length or height. The shape of the cell can be structured to define a coin capacitor assembly or a pouch capacitor assembly, for example.

The first layer 2 can be formed by use of commercial graphite films (e.g. graphite films coated on copper foil) or other carbon material film or sheet of carbon material. The carbon material (e.g. graphite film) can undergo a prelithiation process by pressing the carbon material on a lithium sheet (short-circuiting). Chemical prelithiation can alternatively be done to form the anode of the first layer 2 by soaking the carbon material (e.g. graphite film) in lithium biphenyl or lithium naphthalene or another suitable lithium solution or mixture.

Additionally, the binder used to form the anode electrode can be prelithiated. For example, use of aqueous slurries using polyacrylic acid or carboxylmethylcellulose can allow the prelithiation of the binder during the formation of electrode slurry. Natural graphite, synthetic graphite and hard carbon derived from polymer precursors can be used as the anode material for this process, for example. Additionally, high temperature annealed carbon nanostructures such as carbon onions, nanodiamond, carbon nanotube can also be used. Prelithiated graphite was found to demonstrate capacities >200 mAh/g at 1 C rate in some embodiments of the LIC. It is contemplated that the prelithiation of other carbon material can provide similar functionality.

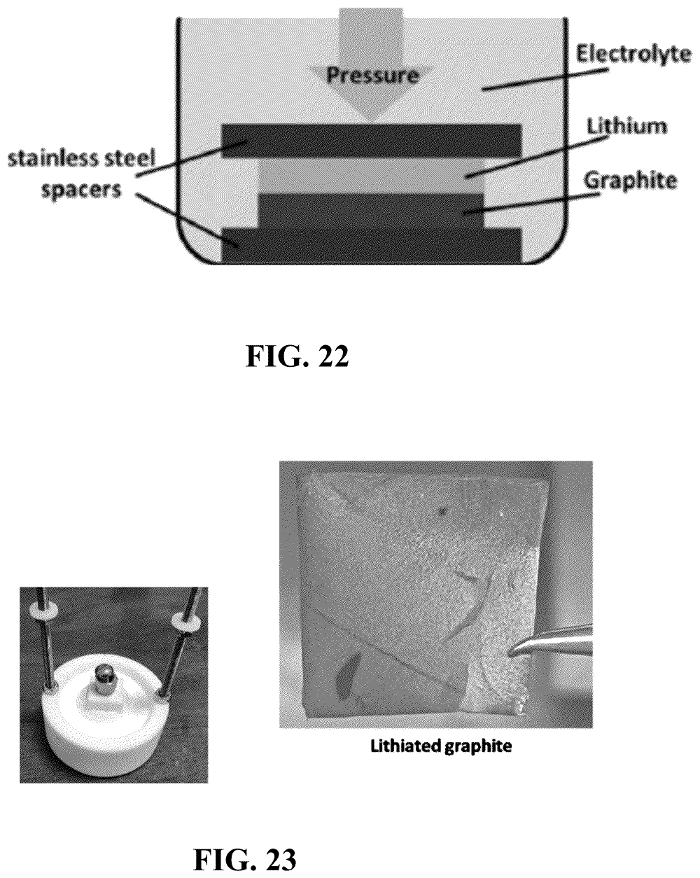

FIG. 22 illustrates an exemplary, scalable process for prelithiation of carbon material anodes for forming the first layer 2. The first layer 2 formed by use of this process can be utilized for a coin cell structure, pouch structure, or other LIC structure. As shown in FIG. 22, spacers can be used to help apply pressure to force a lithium sheet (e.g. lithium metal foil) onto a layer of carbon material (e.g. graphite coated copper foil or graphite coated aluminum foil, etc.). This application of pressure can occur while the spacers, lithium, and carbon material are within a vessel, or tank that includes electrolyte solution. In other applications, the application of the pressure can occur while the carbon material, lithium, and spacers are not in such a solution (e.g. in a pressing apparatus in which the spacers are forced toward each other to press the lithium onto the graphite or other carbon material). After a pre-selected pressure application time period has passed, the pressure can be stopped and the spacers can be moved away from each other for removal of the carbon material layer (e.g. graphite layer) that may be used as the anode layer in the LIC. The lithium material can also be separated from the carbon material and removed. The lithium material may be re-used in a subsequent prelithiation process or may be thrown away. The carbon material that is prelithiated with Li ions due to the prelithiation process, can then be utilized to form an LIC (e.g. be utilized to form a first layer 2 for the anode, etc.).

In some embodiments, conductive tabs (e.g. metal tabs, aluminum tabs, copper tabs, etc.) can be welded onto a graphite electrode prior to the prelithiation process being performed. The prelithiation process that is performed can involve a stamping procedure that results in direct contact of lithium metal foil with graphite coated on copper foils (or aluminum foils or other metal sheet material). The lithiation process can be further facilitated by application of pressure in the presence of electrolyte (e.g. a small amount of electrolyte solution etc.).

The short-circuiting process can result in diffusion of lithium ions into the carbon material resulting in lithiation of the carbon material anode electrode. For instance, graphite in the fully lithiated state forms LiC₆, which can be visually confirmed by the transformation of the black carbon electrode to a golden yellow color (see FIG. 23). LiC₆ is a graphite intercalation compound with a stoichiometry ratio of 1:6 (e.g. 1 Li to 6 C). As discussed above, the process can also be extended to other types of anode materials that include hard carbon anodes, graphene-based anodes, nanostructured carbons such as carbon onions and silicon carbon composite anodes. Graphite coated material therefore is not the only suitable anode material for utilization of the prelithiation process for forming the first layer 2. Other such materials (e.g. hard carbon anodes, graphenebased anodes, nanostructured carbons such as carbon onions and silicon carbon composite anodes) can be used as a substitute for graphite.

We determined that the ex-situ prelithiation process prior to the assembly of pouch cell can eliminate the need for using lithium foil or lithium powder inside the pouch cell. The lithium foil layer or lithium powder for such a cell can be entirely eliminated, for example, for forming embodiments of our LIC. The prelithiation of the carbon material can allow lithium ions to be utilized and available in the anode while avoiding use of lithium in a metal form in the fabricated LIC.

The scalability of the prelithiation process we developed was further demonstrated by uniformly prelithiating graphite electrodes that are 1 inch×1 inch in area and 100 micron thick. The process can be scaled up for large scale roll to roll manufacturing of prelithiated anodes and assembly of lithium ion capacitor pouch cells as well.

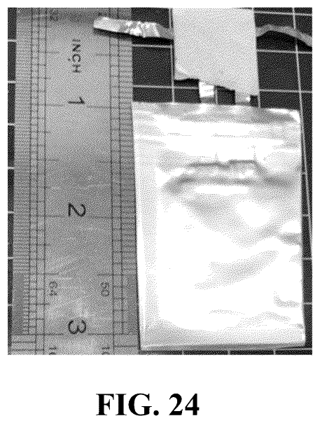

For example, we fabricated an embodiment by using a high surface area carbon cathode coated on an aluminum collector and prelithiated graphite anode coated on copper collector. These layers were assembled together in a pouch cell using a PVDF gel electrolyte membrane or a Celgard separator soaked in 1M LiPF6 dissolved in an ethylene carbonate and dimethyl carbonate (EC/DC) mixture (1:1 by wt.) as the second layer 4. The cathode layer (e.g. third layer 6) had an electrode area of 25.4 mm×25.4 mm while the anode layer (e.g. first layer 2) was made slightly smaller (24.4 mm×24.4 mm) for this particular embodiment. The fabricated pouch cell that was fabricated was 35 mm×50 mm×1.5 mm thick (see FIG. 24). Multiple cells can be assembled in the pouch either in series or parallel configuration to boost the capacitance or voltage of the pouch cell.

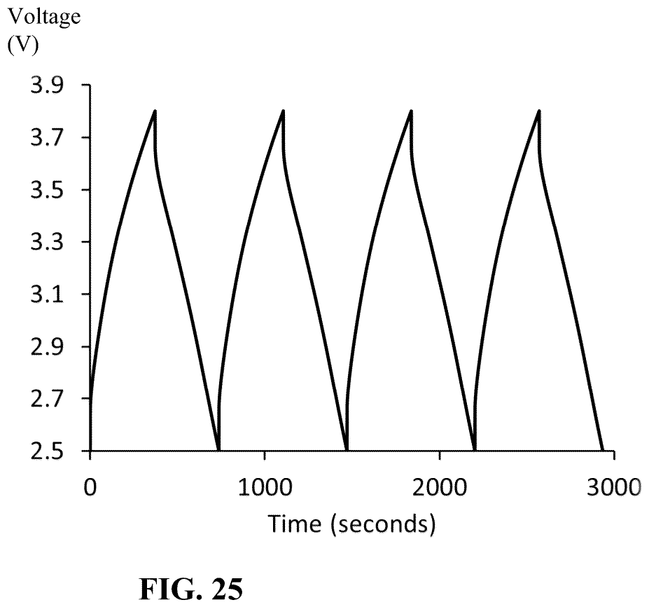

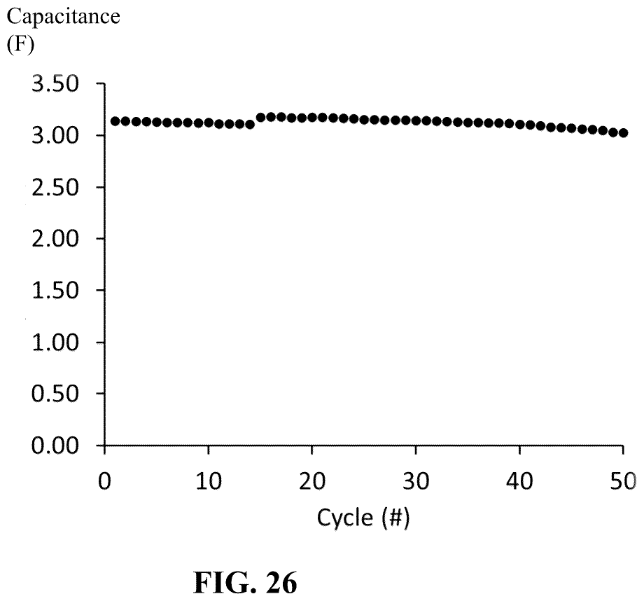

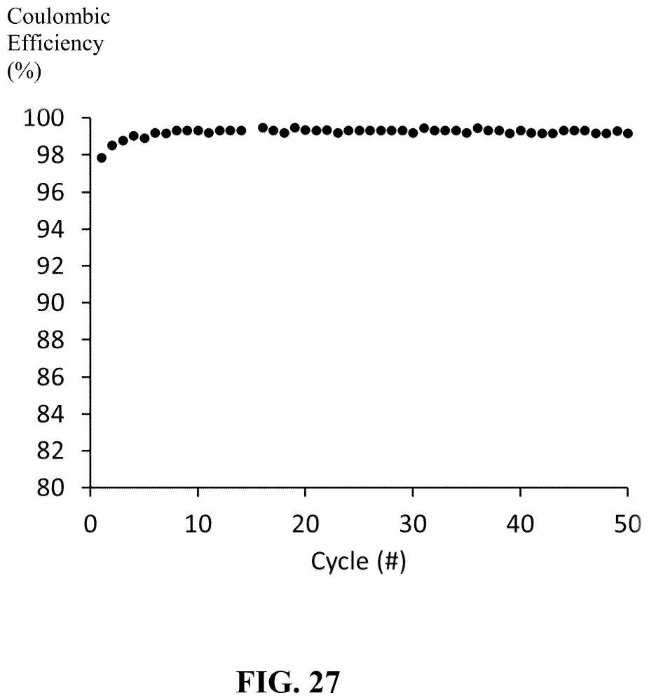

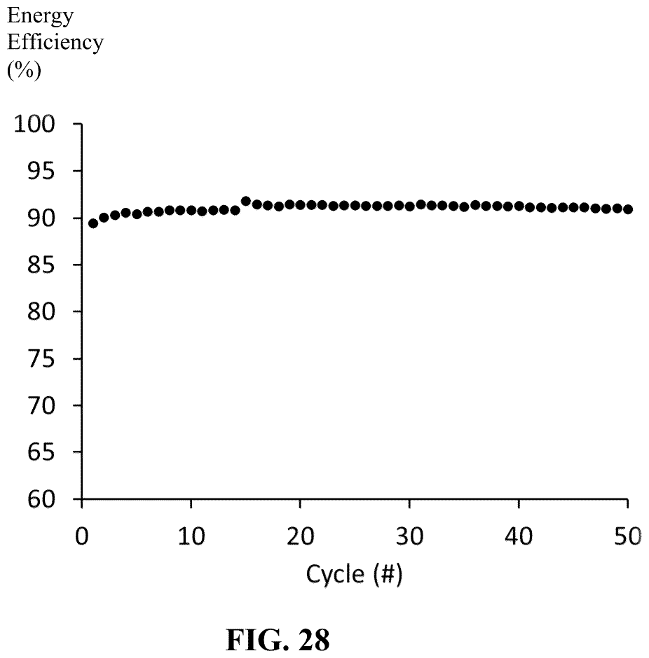

FIG. 25 shows the galvanostatic charge/discharge profile of the assembled lithium-ion pouch cell when cycled using a constant current of 10 mA. The first cycle coulombic efficiency of the assembled cell was 97.86%, which indicates that the solid electrolyte interphase (SEI) formation on the anode during prelithiation, a prerequisite for good cycling performance was well formed and the coulombic efficiency quickly increases to ˜99.5% for the rest of the cycles (see FIG. 27). The energy efficiency of the device was also above 90% for all the cycles (see FIG. 28) and the capacitance stayed high for all these cycles (see FIG. 26).

For fabrication of a first embodiment structured as a coin cell capacitor, graphite films were cut into circular pieces with a diameter of 16 mm. The graphite films then underwent the prelithiation process by pressing it on a lithium sheet (short-circuiting). Bulk densities of the prelithiated graphite film layer for this embodiment was found to be ˜1 g/cc for a particular first embodiment structured as a coin cell having a diameter of 16 mm.

The fourth layer 8 can be a sheet of metal with a pre-selected thickness (e.g. a 0.2 mm stainless steel spacer). The fourth layer 8 can be placed on top of the cathode (e.g. the third layer 6) to help ensure proper contact between electrodes and the LIC coin cell or pouch cell, for example.

For assembly of the LIC 1, it should be appreciated that the layers can be positioned adjacent to each other and subsequently pressed together or otherwise connected to have the desired structure with the alignment and stacking of the first, second, third, and fourth layers. The formed LIC 1 can be formed so that the layers are connected to each other or otherwise in contact with each other as shown in FIG. 1 for example (e.g. second layer 4 contacting the first layer 2 and third layer 6 and third layer 6 contacting the second layer 4 and fourth layer 8).

The formed cell (e.g. coin cell or pouch cell) can be filled with lithium. For example, the formed cell can be filled with a lithium hexafluorophosphate electrolyte.

It should be appreciated that other embodiments may utilize other types of membranes having different thicknesses, a different type of cathode, or a different type of cell structure (e.g., a non-coin cell structure having a different width, length, and/or thickness).

In a fabricated embodiment of our LIC having a diameter of 20 mm and a thickness of 1.6 mm, 45-55 mg of activated carbon and 16 mg of graphite was loaded into a single coin cell. This resulted in an ultra-thick cathode and a cathode-to-anode loading ratio of 3:1.

In addition to the use of high capacity anode and cathode layers, embodiments of the LIC can also be designed to provide a sufficient reservoir of ions to ensure that the double layer formed in the thick cathodes during charging are readily formed without significantly depleting the ion resource in the separator. To provide this design objective for the first exemplary embodiment of the LIC having a diameter of 20 mm and a thickness of 1.6 mm, a membrane or separator was used as the second layer 4 in the device. The second layer 4 can be sufficiently thick and porous to hold enough ions. The membrane in some embodiments can be at least 0.1 mm thick and can be made from various sources that can include, for example, polyvinylidene fluoride (PVDF) and its copolymers, polypropylene, polyacrylamide, polyvinyl alcohol, cellulose acetate or nitrocellulose.

Embodiments of the LIC can also be assembled using a freestanding carbon electrode film or electrode material casted on porous metal current collectors. For instance, high surface area carbon cathode material can be tape casted onto a porous aluminum current collector (0.2 mm-1 mm thick) to form the third layer 6 while the graphite can be casted onto a porous copper anode current collector to form the first layer 2.

Table 2 shows the comparison of performance of high energy density Lithium ion capacitors fabricated using PFA-Ph carbon (an activated carbon made by Kuraray Inc.) and commercial YP-50F carbon (a commercial activated carbon made from coconut shells).

| | | | Equivalent | | |
|---|---|---|---|---|---|
| | Cell Capacitance | | Series | Energy | Power |
| Activated | Material Level | Packaged | Resistance | Density | Density |
| Carbon | (F/g) | Cell (F) | (Ω) | (Wh/L) | (W/L) |
| YP-50F | 45 | 2.7 | 75 | 7.89 | 3.05 |
| PFA-Ph | 64 | 4.7 | 6 | 13 | 3.23 |

For the measured LIC shown in Table 2, each LIC was structured as a coin capacitor that was 20 mm in diameter and 1.6 mm thick. In the fabricated LICs of this particular first embodiment, 45-55 mg of activated carbon and 16 mg of graphite was loaded into a single coin cell. This resulted in an ultra-thick cathode and a cathode-to-anode loading ratio of 3:1. The second layer 4 was a PVDF membrane with a 0.1 mm thickness for this first embodiment of the LIC.

The embodiment of the cell made using commercial cathode material, YP-50F (a commercial carbon derived from coconut shell) showed a cell capacitance of 45 F/g based on mass of both cathode and anode whereas the cell made using PFA-Ph (a carbon made by Kuraray Inc.) had a cell capacitance of 64 F/g. Additionally, the Equivalent Series Resistance (ESR) measured using Impedance spectroscopy at 1 KHz for PFA-Ph was 6Ω as compared to 75Ω. This resulted in an improved energy density of 13 Wh/L based on the total volume of the coin cell as compared to 7.9 Wh/L measured at similar power densities.

### Testing and Cycling Procedure for Evaluation of Embodiments of an LIC

To evaluate performance of the first embodiment of an LIC referenced above, fabricated coin cells were tested in four categories: (1) Ragone analysis, (2) constant current charge-constant power discharge, (3) constant current-constant voltage charge (CCCV), and (4) constant current charge-discharge. In addition, the tests were carried out on a commercial 2016 lithium-ion rechargeable (LIR) battery for the purpose of performance comparison.

### 1. Ragone Analysis

A constant current method was used to charge and discharge an LIC structured as shown in FIG. 1 having the same dimensions as the embodiments discussed above with Table 2 along with a commercially available LIR battery. Current varied from 1 mA to 50 mA. The coin cells were charged and discharged for 10, 15, 20, 25, 35, and 50 cycles for current values less than 10 mA (1, 2.5, 5, 7.5, and 10 mA), 15 mA, 20 mA, 25 mA, 35 mA, and 50 mA respectively. Voltage window was set 2.2-4.0 V for the LIC and 3.0-4.2 V for the LIR battery. The last cycle at each current level was chosen to carry out the performance analysis. Energy density, power density, capacity, and energy efficiency were calculated using the equations in Table 3.

In Table 3, V, I, t_{d}, t_{c}, and v represents voltage (V), current (mA), discharging time(s), charging time(s), and coin cell volume (cm³) respectively. Also, dt denotes incremental change in time. The capacity was plotted with both discharge current and C-rate. C-rate is determined based on discharge time and using equation 1:

$$C - ra te = \frac{3600}{{t}_{d}} ( {h}^{- 1} ) \qquad equation 1$$

TABLE 3
Equations that were used to evaluate performance of the LIC and
LIR battery

| | Equation | Unit |
|---|---|---|
| Energy density | $E = \frac{{\int }_{0}^{{t}_{d}} V \times I \times dt}{3600 \times v}$ | Wh/L |
| Power density | $P = \frac{{\int }_{0}^{{t}_{d}} V \times I \times dt}{v \times {t}_{d}}$ | W/L |
| Capacity | I × t_{d} | mAh |
| Energy efficiency | $\frac{{\int }_{0}^{{t}_{d}} V \times I \times dt}{{\int }_{0}^{{t}_{c}} V \times I \times dt}$ | % |

### 2. Constant Current Charge-Discharge Cycling

Long-term performance of the coin calls was evaluated through constant current charge-discharge cycling. A constant current of 8 mA was chosen to demonstrate fast charging and discharging capability.

### 3. Constant Current-Constant Voltage Charging

Constant current-constant voltage charging is a standard methodology for long-term testing of batteries. Addition of a constant voltage step allows batteries to fully charge and improves cycling stability of batteries. In this technique, a constant current charge of 2.5 mA was applied to both the LIC and LIR battery, followed by one-hour constant voltage charging, and constant current of 2.5 mA discharging.

### 4. Constant Current Charge-Constant Power Discharge Cycling

This test is designed to simulate performance of the LIC and LIR battery in actual applications that require constant power input. The coin cells charged in a constant current mode and discharged in a constant power mode. The voltage window was set to 3.0 to 3.8 V. Testing specification is described in table 4.

TABLE 4
Procedure for constant current charge -
constant power discharge cycling

| | Charging | Discharging | Cycle number |
|---|---|---|---|
| Step | current mA | power mW | # |
| a | 3 | 3 | 100 |
| b | 5 | 5 | 100 |
| c | 8 | 8 | 100 |
| d | 8 | 10 | 100 |
| e | 8 | 15 | 100 |
| f | 8 | 20 | 100 |
| g | 8 | 25 | 100 |

Capacity was calculated during discharge (current multiplied by discharge time—I*t_{d}) and the capacity retention was compared for both LIC and LIR battery.

### Performance and Demonstration of Use of Embodiments of an LIC Capacitor

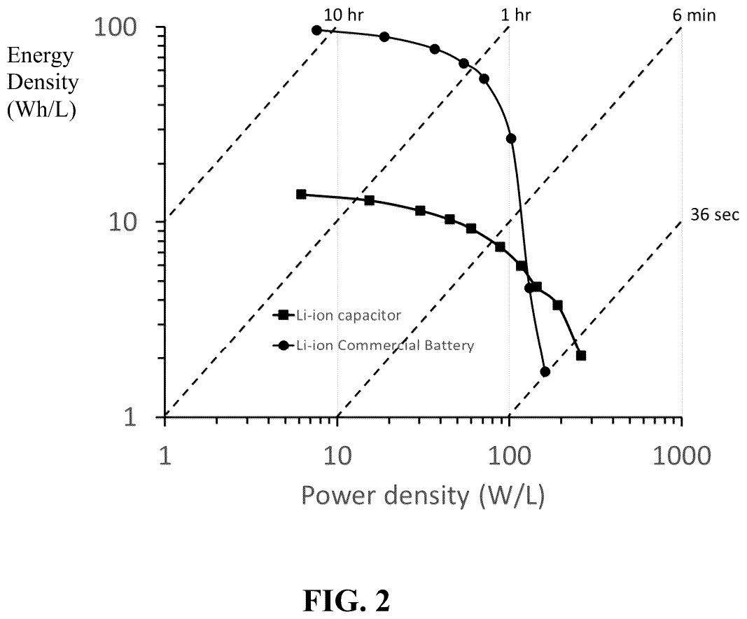

The performance of a fabricated embodiment of our capacitor as an LIC capacitor was compared against a commercial rechargeable 2016 lithium-ion battery. A typical, conventional button cell rechargeable battery operates at 3.6V with a deliverable capacity of 12-15 mAh at 0.2 C (charge time ˜5 hours). The cycle life of most conventional batteries when charged with nominal current of 1-2 mA under CCCV is limited to 70% capacity retention over 500 cycles. The Ragone plot was constructed for both an embodiment of our LIC as noted above and the conventional LIR battery using constant current charge/discharge tests and is shown in FIG. 2.

As can be seen from FIG. 2, the maximum volumetric energy density of packaged LIC that we fabricated was 13 Wh/L. The energy density remained above 10 Wh/L until the load current was increased above 10 mA and slowly reduced to 2 Wh/L for load current of 50 mA.

The commercial LIR battery had a higher maximum energy density of 100 Wh/L compared to the LIC we fabricated, however, the knee of the curve where the energy density starts to drop occurs when the load current increased above 5 mA. The optimum energy to power performance can also be defined by the knee of the curve which suggests that the conventional battery requires at least 1 hour to charge (i.e. 1 C rate) to provide high energy density. On the other hand, with LIC, the knee of the curve tapered more gradually and the optimum performance suggests a charging time of 3-4 min.

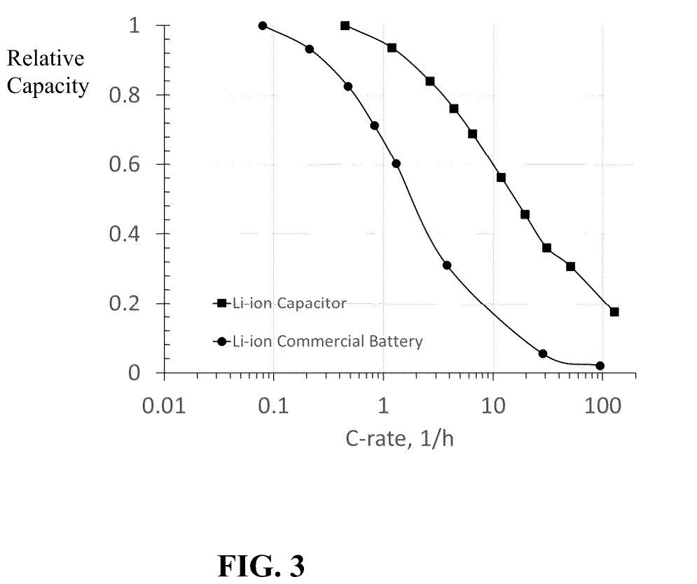

The impact of C-rate on the performance of the devices can also be seen by plotting the fading in capacity in percentage terms (%) with increase in C-rate (FIG. 3). Our LIC embodiment shows more % capacity retention at higher C-rate relative to the conventional LIR battery. For 80% capacity retention, the LIR battery needs to be charged at 0.5 C while the embodiment of our LIC can be charged at 3.5C. The LIC retains 20% of its original capacity even at extremely high C-rate of 100 C. And embodiments can be configured to work in conjunction with wireless charging.

It should be appreciated that the C rate, or C-rate, is defined as charging/discharging time of 1 hour. For example, a 5 C rate implies the charging/discharging time is 12 minutes, a 10 C rate implies the charging/discharging time is 6 minutes, etc.

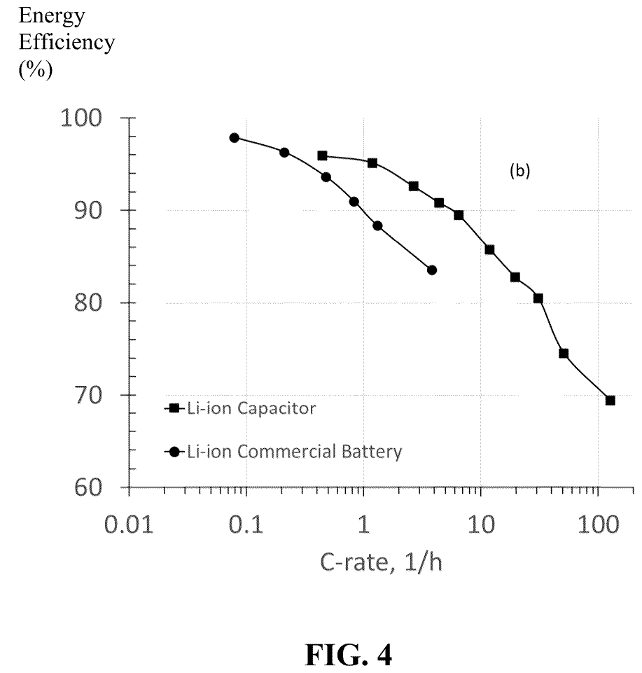

Another parameter that highlights superior charge retention capability of the embodiment of our LIC is the plot of energy efficiency versus C-rate (FIG. 4). For a charging energy efficiency of 90%, LIR battery can be charged at ˜0.8C while LIC can be charged at 5 C. Even at a remarkably high C-rate of 100 C, the energy efficiency was 70%. These results show that the embodiment of our LIC can provide energy efficient solution for fast charging or high pulsed current loading conditions.

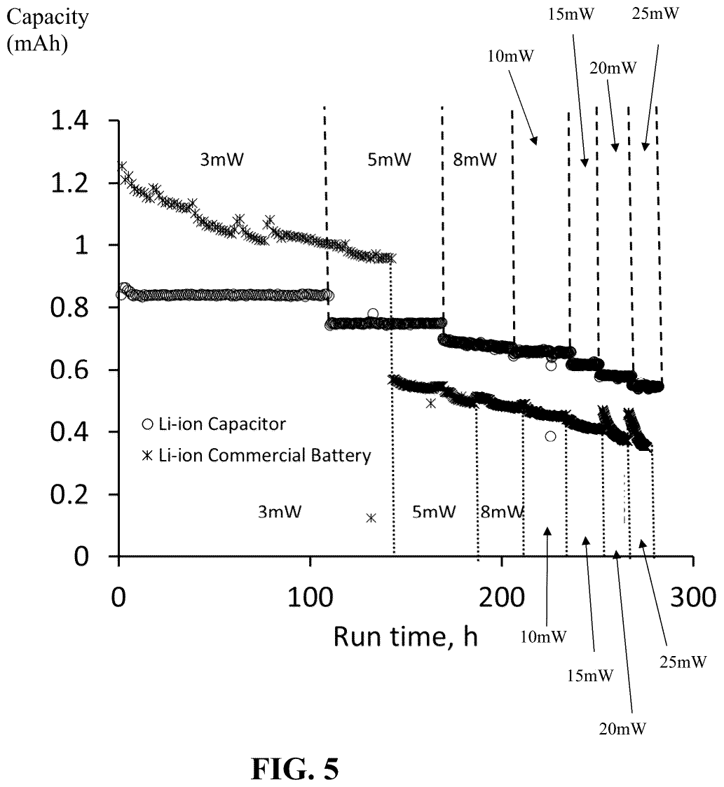

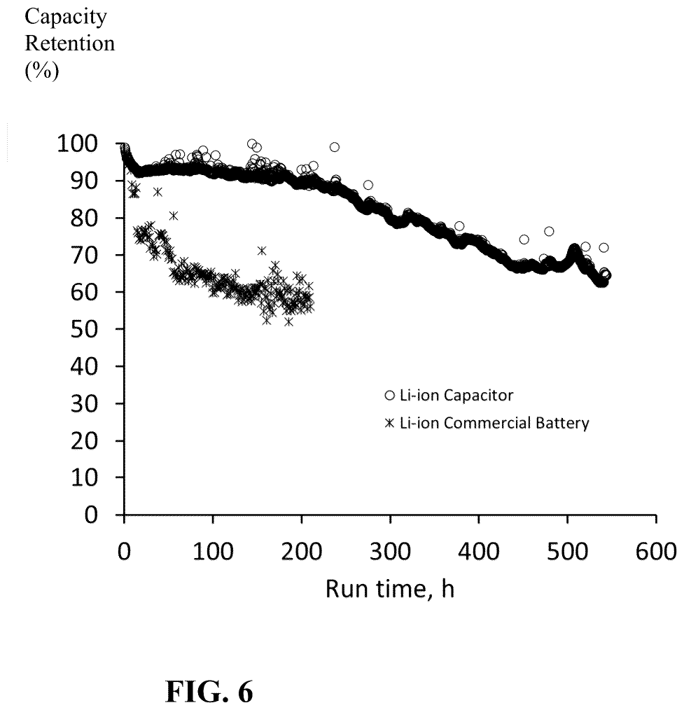

In many applications, sensors are often designed for a constant power input from energy storage. For evaluation of this parameter, both the embodiment of our LIC and the conventional LIR battery underwent the constant current charge-constant power discharge test that is described in the above Table 3 with the voltage window of 3.0 to 3.8 V. Capacity and capacity retention were plotted vs run time as shown in FIG. 5. The capacity delivered by the LIR battery was greater than the LIC at discharge power <5 mW and once the demand exceeds 5mW, the performance of LIR battery significantly drops while the capacity of the LIC gradually decreases. The LIC, even at 20 mW constant power discharge, can deliver 80% of its original capacity as compared to the conventional LIR battery, which only provided 40% of its original capacity. Long-term cycling stability was evaluated by doing constant current charge/discharge experiments at 8 mA as shown in FIG. 6 for the embodiment of our LIC and the conventional LIR battery. Both coin cells were cycled until the capacity retention of 60% was reached. Based on FIG. 6, the LIC when operated continuously lasted for almost three times more as compared to the LIR battery (550 hours to 210 hours). The embodiment of the LIC's initial capacitance was 3.9 F and after 2000 cycles at 8mA, the capacitance dropped to 2.6 F (>65% capacitance retention). Energy efficiency (˜90%) and coulombic efficiency (˜100%) were similar for both coin cells during cycling. The LIC's ESR remained below 10Ω after the long-term cycling.

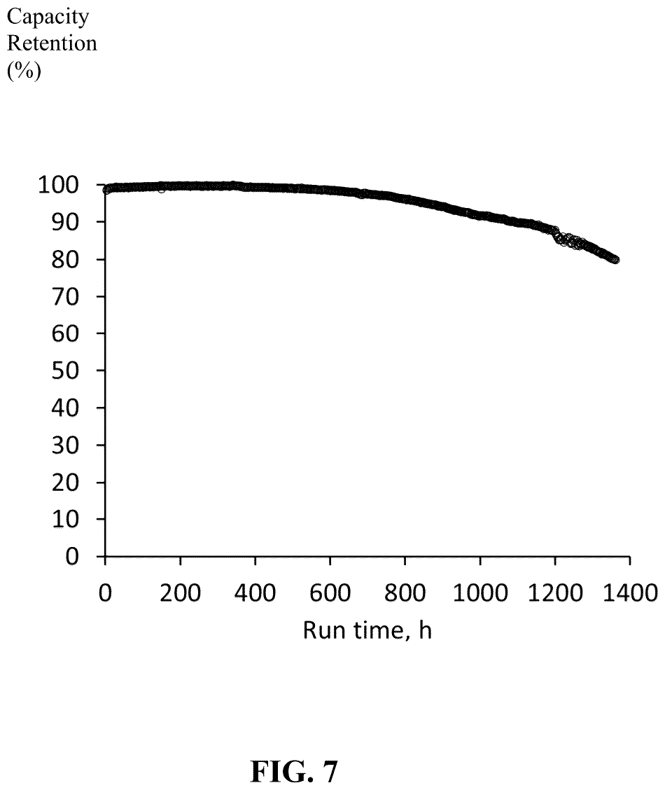

FIG. 7 shows the long-term cycling using constant current constant voltage measurements. The embodiment of our capacitor was charged at 2.5 mA up to 3.8V and was held for 1 hour at 3.8V before discharging at 2.5 mA. The capacitance retention under the CCCV condition was over 80% for 1400 hours.

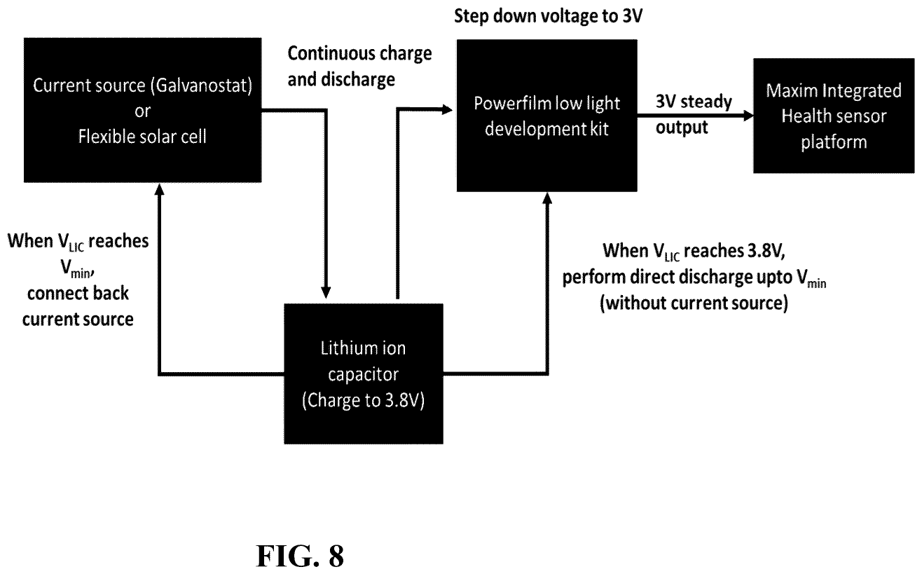

FIG. 8 illustrates a methodology for charging of an embodiment of our LIC using a constant current source or a flexible solar cell. For the particular embodiment shown in FIG. 8, the maximum charging voltage was limited to 3.8V. Other embodiments can use a different pre-selected maximum charging voltage. The particular charging embodiment of FIG. 8 was utilized in performance of other analysis and testing of an embodiment of our LIC discussed below.

A buck converter was used in this work to provide a steady voltage output of 3V to a health sensor platform. When the voltage reached the pre-selected maximum voltage (e.g. 3.8V), the current charging source was disconnected and the health sensor was run directly by the capacitor until the voltage reached a minimum voltage (Vmin), which was set to a value of between 2.5V and 3.4V for this particular demonstration. It should be appreciated that other embodiments utilizing an embodiment of the charging method can utilize a different Vmin or different pre-selected minimum voltage.

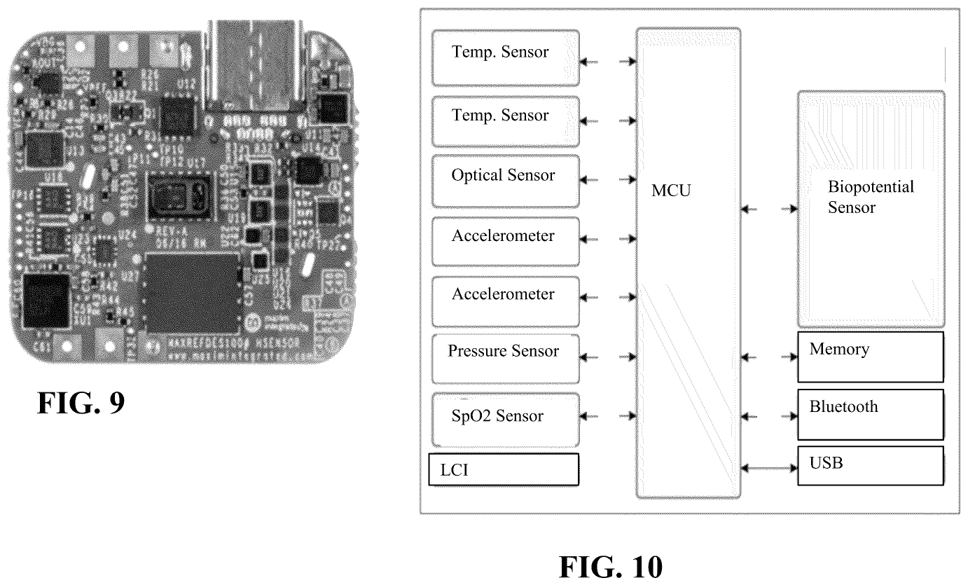

The fabricated capacitor packaged in the coin-cell prototype with cell capacitance as high as 4.7 F was then charged either using a constant current source or flexible solar cell and was used to power a Maxim Integrated Health sensor platform (Maxrefdes100) as shown in FIG. 9 and FIG. 10.

The embodiment of our LIC was coupled to the sensor platform using a Powerfilm low light development kit that helped to step down the voltage of the capacitor to 3V in order to maintain steady voltage output to run the health sensor platform. The capacitor was simultaneously continuously charged using either a galvanostat or flexible solar cell while running the sensor platform until the voltage reached 3.8V. When the voltage of the capacitor reached 3.8V, the charging source was cut-off and the LIC directly powered the health sensor platform until the voltage of the capacitor reached the Vmin threshold. The value of Vmin ranged between 2.5V-3.4V during this testing work and could have been set to a value lower than 2.5V (e.g. as low as 2.2V).

FIGS. 9 and 10 show a Maxim Integrated Health sensor platform (Maxrefdes100) that has two temperature sensors (Temp. Sensor), a pressure sensor, an optical heart rate sensor (Optical Sensor), blood oxygen saturation sensor (SpO2 sensor), accelerometer, gyroscope and ECG (Biopotential Sensor) with a Bluetooth low energy chip (Bluetooth) for transmitting the data. The platform also included memory (e.g. flash memory), a microcontroller (MCU) and a universal serial bus (USB) interface. An embodiment of our LIC was utilized to provide power for this sensor platform to evaluate its usability as a power source or power source component.

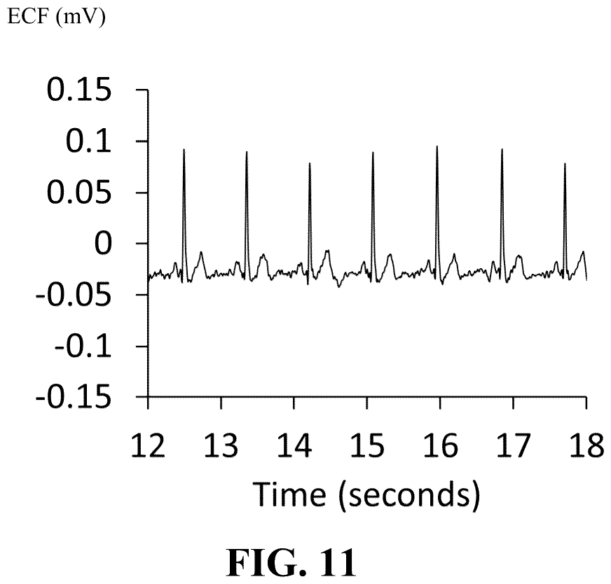

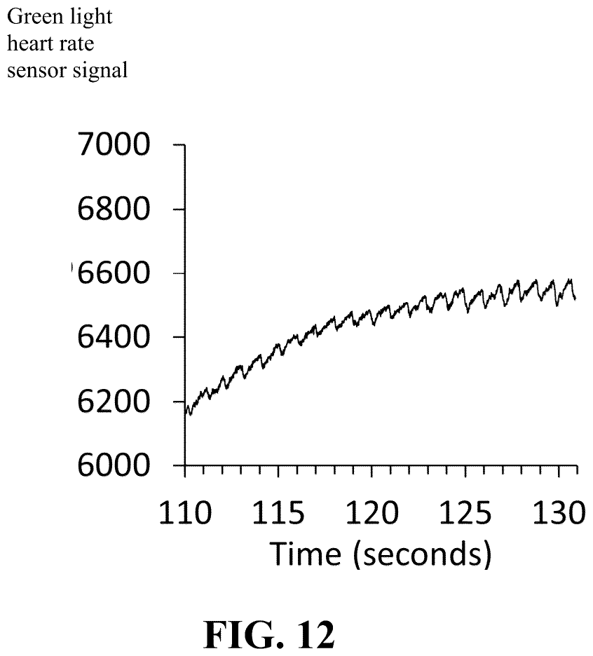

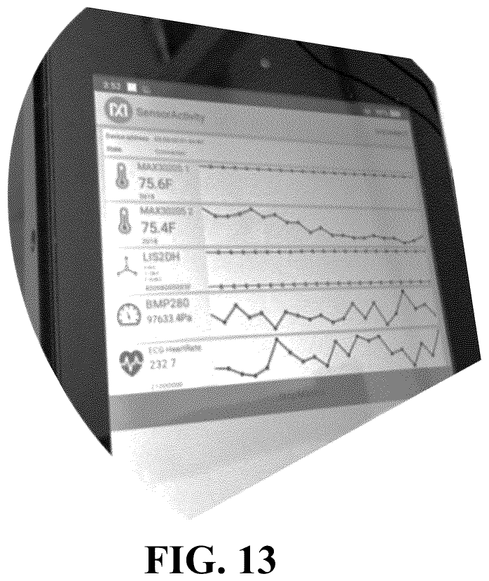

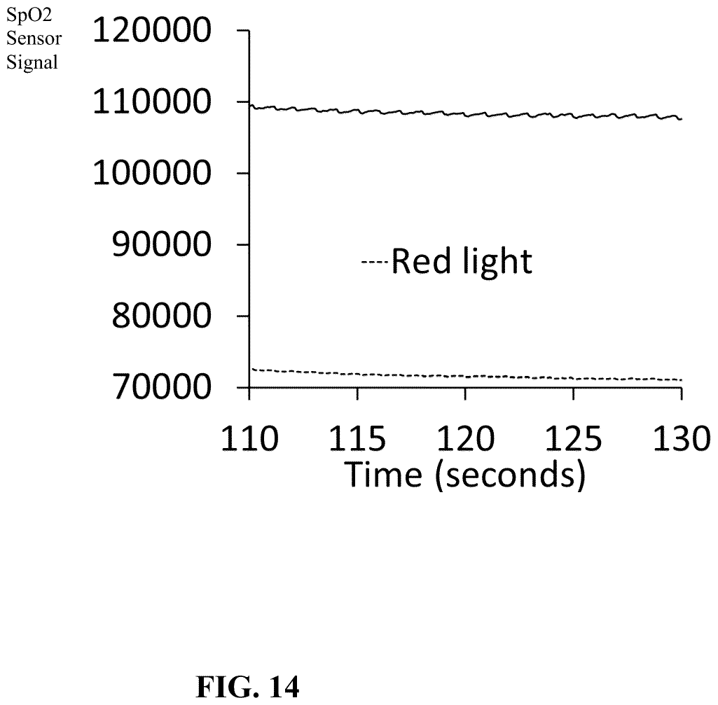

FIG. 11 show the operation of optical sensors using the solar powered LIC capacitor (middle). FIG. 12 illustrates green light data that shows the optical heart rate signal while FIG. 14 shows the SpO2 sensor signal. Echocardiogram (ECG) data monitored using the sensor platform and real-time data transmitted and monitored using an Android App. can also be appreciated from the photograph of FIG. 13.

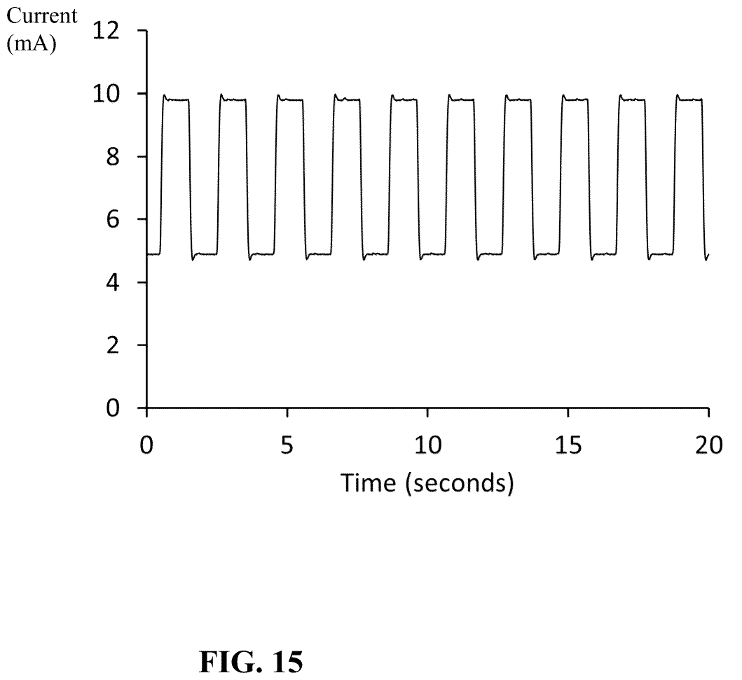

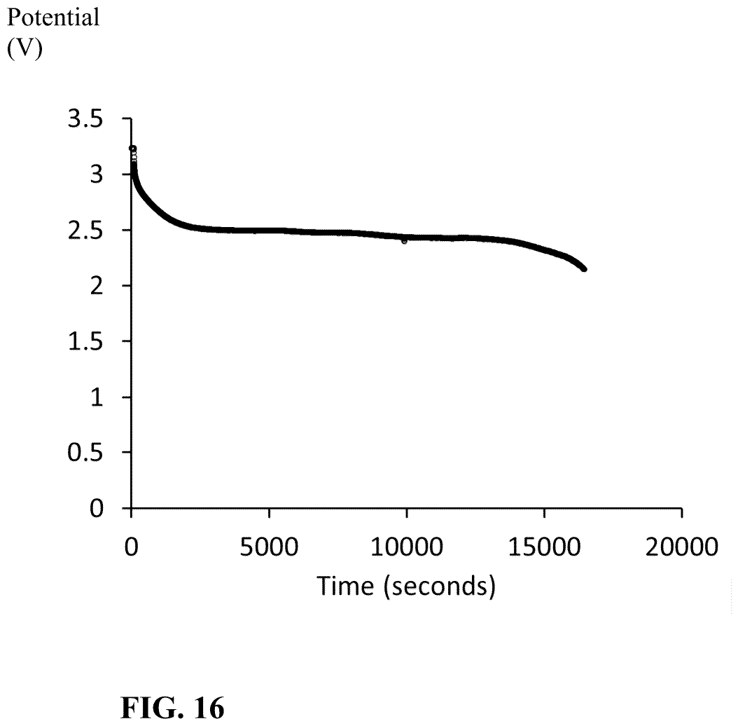

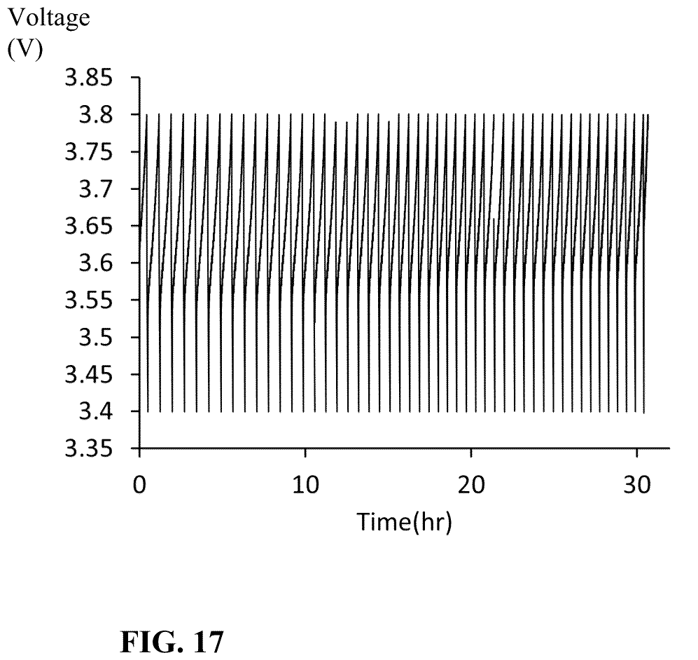

FIGS. 15-17 illustrate the pulsed load current profile of the health sensor platform under operation (FIG. 15)), voltage profile of CR2032 primary lithium-ion battery while running the health sensor platform (FIG. 16), and Voltage profile of an embodiment of our LIC capacitor continuously running the health sensor platform while being charged by solar cell or constant current source (FIG. 17).

FIGS. 15-17 provide a comparison of the performance of the embodiment of an embodiment of our fabricated lithium-ion capacitor against the conventional CR 2032 3V commercial Li-ion primary battery. From FIG. 15, we can see a typical pulsed load current profile ranging from 5 mA to 10 mA. The conventional CR2032 battery, which has a capacity of 230 mAh under the pulsed load conditions, can only run continuously for 4.6 hours. On the other hand, the embodiment of our LIC when powered using an indoor light-based solar cell can run continuously for more than 30 hours. The voltage of the capacitor during the run was maintained between 3.4V-3.8V.

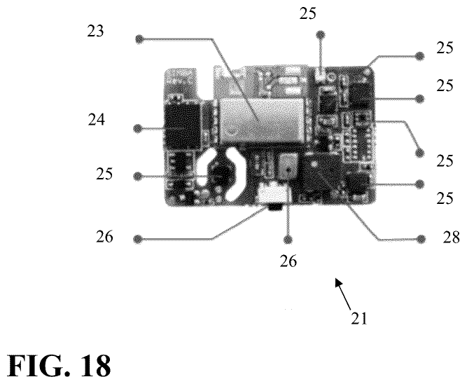

FIG. 18 illustrates an internet of things (IOT) sensor module with a Bluetooth transceiver unit 23 connected to a microcontroller (MCU), which can also be referred to as a microcontroller unit. The MCU is also connected to a non-transitory memory 24, various environmental sensors 25, input devices 26 (e.g. buttons, a microphone), and an output device 28 (e.g. a speaker). The sensors 25 can include optical sensors (e.g. LEDs), pressure sensors, temperature sensors, and an accelerometer, for example.

The embodiment shown in FIG. 18 is based on a SIMBA PRO system on module developed by SENSI Edge that has multiple sensors 25 that include relative humidity and temperature sensor, digital microphone, magnetic sensor, accelerometer and gyroscope, light sensor and pressure sensors. The system on module was again powered using an embodiment of our fabricated LIC in conjunction with solar cell.

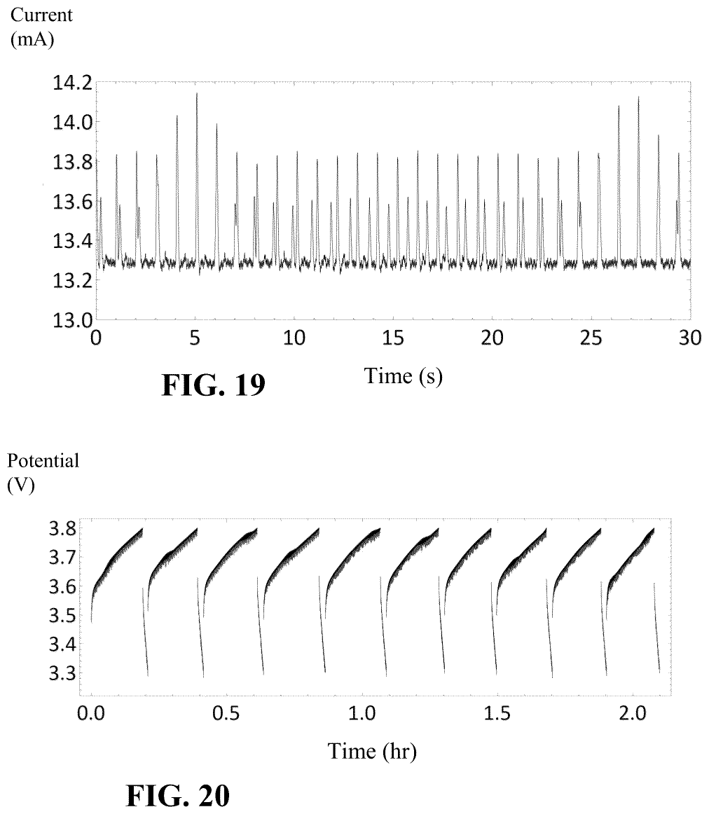

FIGS. 19 and 20 illustrate results of testing performed using the embodiment of FIG. 18 having an embodiment of our LIC included therein. FIG. 19 shows the pulsed load current profile of the IOT sensor module, which ranged from 13-14 mA. FIG. 20 shows the voltage of the capacitor, which varied between 3.3V to 3.8V during the run. The capacitor ran continuously overnight over almost 80 cycles with no fading in the performance.

In addition to the health sensor platform applications and IOT sensors applications discussed above, embodiments of our fabricated LICs can provide superior energy density, self-discharge performance and wide load current capability ranging from 10 μA-50 mA for advantageous utilization in other technology areas and industries. For example, embodiments can be utilized in at least the following applications: on-board CPU Memory backup circuits; real time clock—battery backup; smart utility meters; solar battery backup and energy storage; hybrid car batteries, electric vehicle batteries, hybrid vehicle batteries, laptop computer batteries, smart phone batteries, tablet batteries, communication equipment rechargeable batteries, consumer electronics rechargeable batteries, and industrial controls.

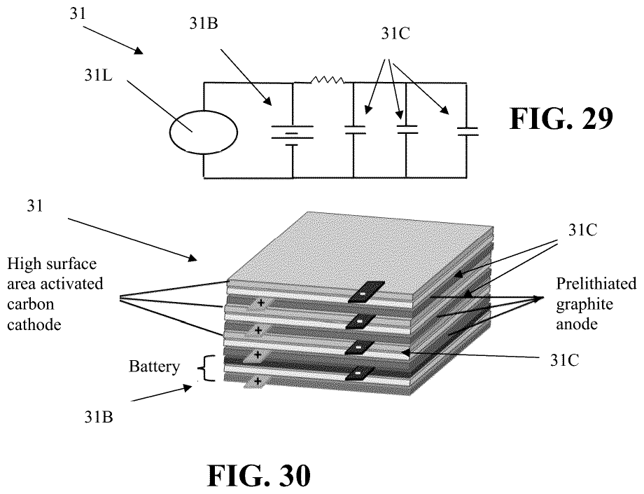

For example, embodiments of the LIC can also be extended to hybrid modular assembly 31 that can define lithium-ion capacitors 31C and a lithium ion rechargeable battery 31B inside the same pouch cell. The use of the high energy density lithium ion capacitor 31C inside the pouch cell can facilitate the fast charging of the module 31. FIGS. 29 and 30 illustrate an exemplary design that employs embodiments of our LIC into a hybrid module.

As an exemplary illustration, a hybrid module 31 can be assembled using a 3.7V Lithium ion rechargeable battery 31B with a specific capacity of 6 mAh/cm² in parallel with three cells of LIC (5.7 F each). The battery 31B can be connected to a load or current source 31L.

The 5.7 F LIC capacitors 31C can be based on assembly of a 0.6 g/cc high surface area carbon cathode that is 200 μm thick and a prelithiated graphite anode with a mass ratio of 3:1, respectively. In this particular exemplary design, the use of three capacitors in parallel with the battery can account for 20% of the battery capacity and can help the battery charged and discharged to 60% of its capacity in 36 minutes. The cycle life of a conventional battery can significantly goes down when it is charged and discharged above a 1 C rate. Utilization of an embodiment of our design can avoid both high discharge rate and deep discharge of the battery while the module collectively could provide 80% of the battery capacity due to the use of high energy density LICs. FIGS. 29-30 provide exemplary illustrations of an embodiment of such a design.

It should be appreciated that the capacitors 31C and battery 31B can be designed to utilize different voltages, currents, and capacities and use other type of thicknesses and prelithiated anodes having different mass ratios than the exemplary embodiment discussed above. This embodiment is exemplary in nature to help further illustrate the different applications for different embodiments of our LIC.

A hybrid vehicle battery, electric vehicle battery, or other rechargeable battery can utilize one or more modules 31 or other embodiments of a module 31 that includes an array of our LICs therein. The LICs can be arranged in series or in parallel to provide a desired functionality to meet a particular set of design criteria. In some embodiments, a group of LICs can be arranged in series and there may be multiple such groups arranged in parallel. The design of the module can be configured to meet a particular set of design criteria related to a number of factors including, for example, a desired charging time, a desired operational voltage range, a desired operational current range, and a desired form factor.

It should be appreciated that different embodiments of the method, LIC fabrication apparatus, and devices utilizing the LIC can be developed to meet different sets of design criteria. For example, the particular length, width, and thickness of different layers of the LIC, the arrangement of one or more LICs in parallel and/or in series of a particular assembly, and the particular shape of the layers (e.g. coin, pouch, etc.) can be adapted for a particular type of application. As another example, the capacity and desired operational voltage range and/or current range can be adapted to meet a particular set of design criteria.

As yet another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of a LIC, apparatus for fabrication of an LIC, devices that utilize the LIC, and methods of making and using the same have been shown and described above, it is to be distinctly understood that the invention is not limited thereto but may be otherwise variously embodied and practiced within the scope of the following claims.

1. A capacitor comprising:
a cathode layer;
an anode layer;
a membrane between the cathode layer and the anode layer.

2. The capacitor of claim 1, comprising a spacer layer attached to the cathode layer.

3. The capacitor of claim 1, wherein the anode layer is comprised of a prelithiated carbon material coated on a metal or a prelithiated graphite coated on a metal.

4. The capacitor of claim 3, wherein the cathode layer includes activated carbon.

5. The capacitor of claim 1, wherein the cathode layer comprises activated carbon and the anode layer is comprised of a prelithiated carbon material.

6. The capacitor of claim 1, comprising:
a spacer layer attached to the cathode layer, the spacer is comprised of metal. or stainless steel

7. The capacitor of claim 1, wherein the anode layer is comprised of a prelithiated graphite that is prelithiated via a chemical approach or via a short circuit approach.

8. The capacitor of claim 1, wherein the membrane is prelithiated via a chemical approach or via a short circuit approach.

9. The capacitor of claim 1, wherein the capacitor is a lithium-ion capacitor.

10. A method of fabricating a capacitor comprising:
forming a cathode layer, an anode layer and a membrane between the cathode layer and the anode layer to form the capacitor of claim 1; and
wherein the anode layer, membrane, and the cathode layer are arranged without lithium in metal form being included in the capacitor.

11. A method of fabricating a capacitor comprising:
prelithiating a carbon material to form a first layer for the capacitor, the first layer including an anode;
positioning a second layer between the first layer and a third layer, the second layer including a membrane and the third layer including a cathode, the cathode comprising activated carbon.

12. The method of claim 11, comprising:
connecting a fourth layer to the third layer, the fourth layer comprised of a metal.

13. The method of claim 11, wherein the capacitor is formed so that the capacitor does not include a layer of lithium foil or lithium powder.

14. The method of claim 11, wherein the capacitor is a lithium ion capacitor (LIC) and consists of the first layer, the second layer, and the third layer.

15. The method of claim 11, wherein the capacitor is a lithium ion capacitor (LIC) and consists of the first layer, the second layer, the third layer and a fourth layer connected to the third layer, the fourth layer comprised of metal.

16. The method of claim 11, wherein the activated carbon is synthesized based on polymerization and pyrolysis of furfuryl alcohol.

17. The method of claim 16, wherein the carbon material is graphite.

18. The method of claim 1, wherein the capacitor is formed so that the capacitor does not include lithium in metal form.

19. The method of claim 11, wherein the carbon material is a carbon anode, a graphene-based anode, a carbon onion anode, or a silicon carbon composite anode.

20. A device comprising:
at least one capacitor comprising:
a first layer;
a second layer;
a third layer, the second layer being positioned between the first layer and the third layer;
the second layer being a membrane;
the first layer comprising a prelithiated carbon material; and
the third layer comprising activated carbon.

21. The device of claim 20, wherein the device is included in a rechargeable battery, an on-board computer memory backup circuit; a real time clock—battery backup; a utility meter; a solar battery backup and energy storage device; a hybrid car battery, an electric vehicle battery, a hybrid vehicle battery, a laptop computer battery, a smart phone battery, a tablet battery, and an industrial control device.

22. The device of claim 20, wherein the first layer, second layer, and third layer are arranged without a layer of lithium in metal form positioned between the layers or adjacent the layers and without the layers having lithium in metal form.

23. The device of claim 20, wherein the at least one capacitor is at least two capacitors, each of the capacitors having the first layer, the second layer, and the third layer, the capacitors being connected to each other.

24. The device of claim 23, wherein the at least two capacitors are within a single pouch cell.
